(19) United States
(12) Patent Application Publication
(10) Pub. No.: US 2010/0038192 A1
(43) Pub. Date: Feb. 18, 2010

(54) FLOATING YAW BRAKE FOR WIND TURBINE

(76) Inventor: Michael O. Culbertson, Cuyahoga Falls, OH (US)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/541,368

(22) Filed: Aug. 14, 2009

Related U.S. Application Data
(60) Provisional application No. 61/174,176, filed on Apr. 30, 2009.
(60) Provisional application No. 61/089,069, filed on Aug. 15, 2008.

(51) Int. Cl. F16D 55/2255

(52) U.S. Cl. 188/73.31

(57) ABSTRACT

A yaw brake for a wind turbine having a brake disk, the yaw brake comprising: a brake caliper; a brake lining associated with the caliper; at least one of an electromechanical actuator and a hydraulic actuator; and a plurality of torque pins. Each pin is mounted through the brake caliper by a spherical bearing such that the caliper can slide and tilt in relation to the torque pins to reduce misalignment between the brake lining and the brake disk.

### CROSS-REFERENCE TO RELATED CASES

The present application claims the benefit of the filing date of U.S. Provisional Application Ser. No. 61/174,176; filed Apr. 30, 2009, and U.S. Provisional Application Ser. No. 61/089,069; filed Aug. 15, 2008, the disclosures of which are expressly incorporated herein by reference.

### TECHNICAL FIELD

The present invention relates to a braking system for a wind turbine, and in particular, to a floating yaw brake for a wind turbine that provides improved brake performance by reducing or eliminating brake misalignment.

### BACKGROUND

The general objective of a wind turbine yaw drive is to direct the wind turbine into the direction of the wind. The most common type of yaw mechanism is based on a rolling slewing bearing with a cogged inner or outer race and several pinions driven by electrical or hydraulic motors over high-reduction gearboxes. When not yawing the machinery is positively locked by means of several yaw brake calipers acting on a brake disc. Some of the calipers are also activated during yawing, in order to introduce damping into the system.

Current yaw brakes are rigidly fixed to the tower frame using eight to twelve bolts depending on the brake size. There are two to three pistons on each side of the brake disc which supply clamping force for the brake. Since the brake is rigidly fixed to the tower frame, the brake cannot accommodate misalignment in the brake disc. When misalignment occurs, the surface area of the friction material decreases which increases the energy per square inch. The increased energy and wear creates vibration, noise and loss of torque (fade).

### SUMMARY

At least one embodiment of the invention provides a yaw brake for a wind turbine having a brake disc, the yaw brake comprising: a brake caliper; a brake lining associated with the caliper; at least one of an electromechanical actuator and a hydraulic actuator; and a plurality of torque pins. Each pin is mounted through the brake caliper by a spherical bearing such that the caliper can slide and tilt in relation to the torque pins to reduce misalignment between the brake lining and the brake disk.

### BRIEF DESCRIPTION OF THE DRAWINGS

Embodiments of this invention will now be described in further detail with reference to the accompanying drawing, in which:

FIG. 1 is a perspective view of the an embodiment of the floating yaw brake of the present invention;

FIG. 2 is a perspective view of the floating yaw brake of FIG. 1 shown engaging a yaw brake disc;

FIG. 3 is a side perspective view of the floating yaw brake of FIG. 1 shown in a tilted position about the Z axis in the Y direction;

FIG. 4 is a front perspective view of the floating yaw brake of FIG. 1 shown in a tilted position about the Z axis in the X direction;

FIG. 5 is a side perspective view of the floating yaw brake of FIG. 4; and

FIG. 6 is a cross sectional side view of the yaw brake of FIG. 5.

### DETAILED DESCRIPTION OF THE DRAWINGS

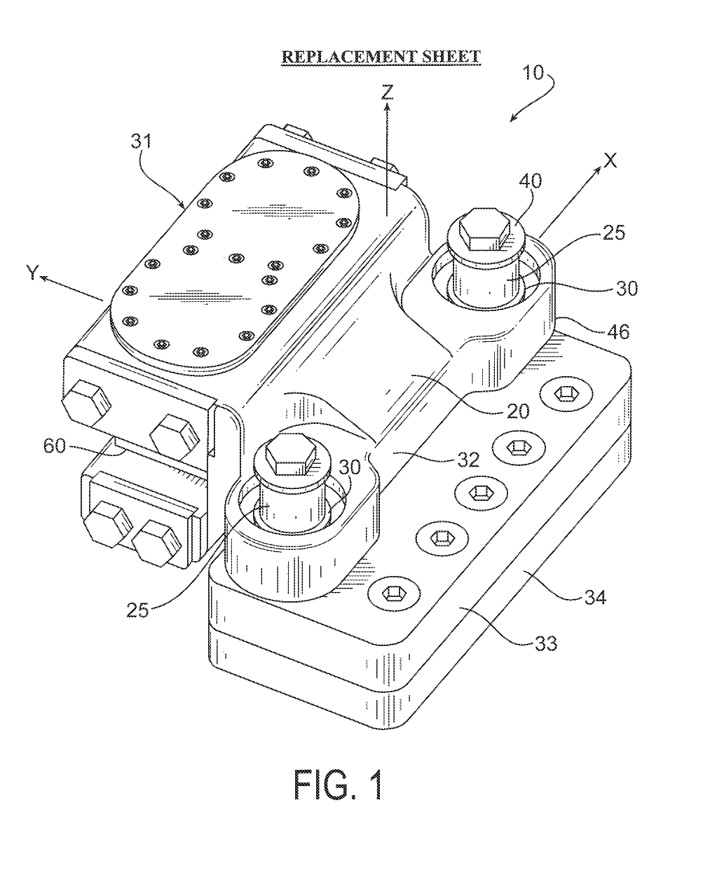

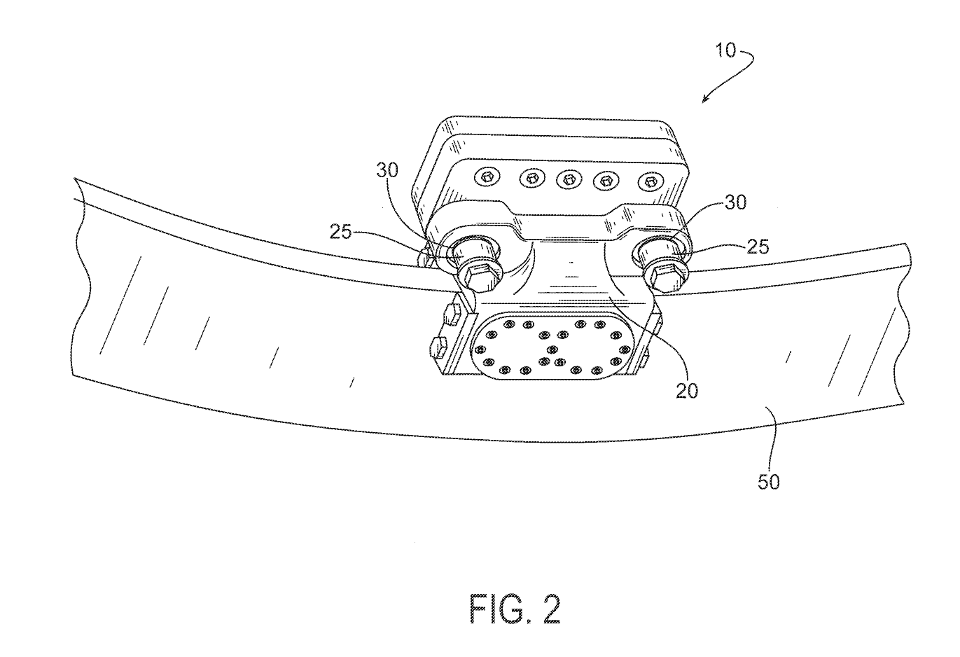

Referring initially to FIGS. 1 and 2, an embodiment of the floating yaw brake 10 is shown. The yaw brake 10 comprises a caliper assembly 20 and is mounted to the wind turbine by torque pins 25 to transmit the torque to the base frame (not shown). As will be described herein in more detail, the yaw brake 10 comprises spherical bearings 30 between the caliper assembly 20 and the torque pins 25 that allow misalignment. This enables the brake structure 20 to tilt about the “Z” axis, and well as have a certain degree of sliding movement along the “Z” axis. The brake includes an actuator, indicated generally at 31, such as for example, a hydraulic or electromechanical actuator as shown and described in U.S. patent application Ser. No. ______, to Culbertson, et al., for “Modular Actuator for Wind Turbine Brake” (“Modular Actuator Application”), filed concurrently herewith, and which is incorporated herein by reference. The actuator includes a piston or other actuating member that provides a reaction force which is transferred through the brake structure to the opposite side of the brake disk 50 to engage or disengage the brake.

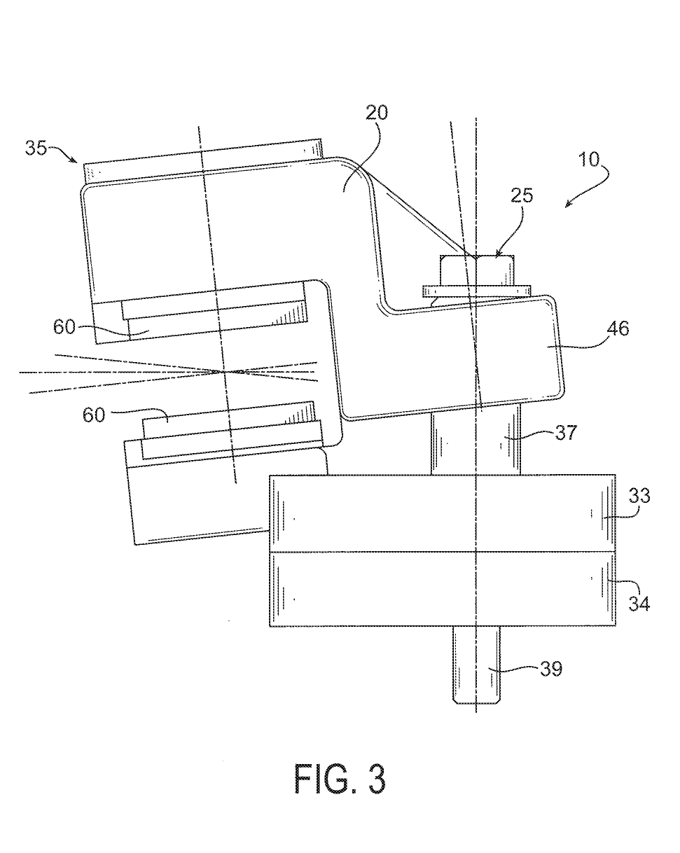

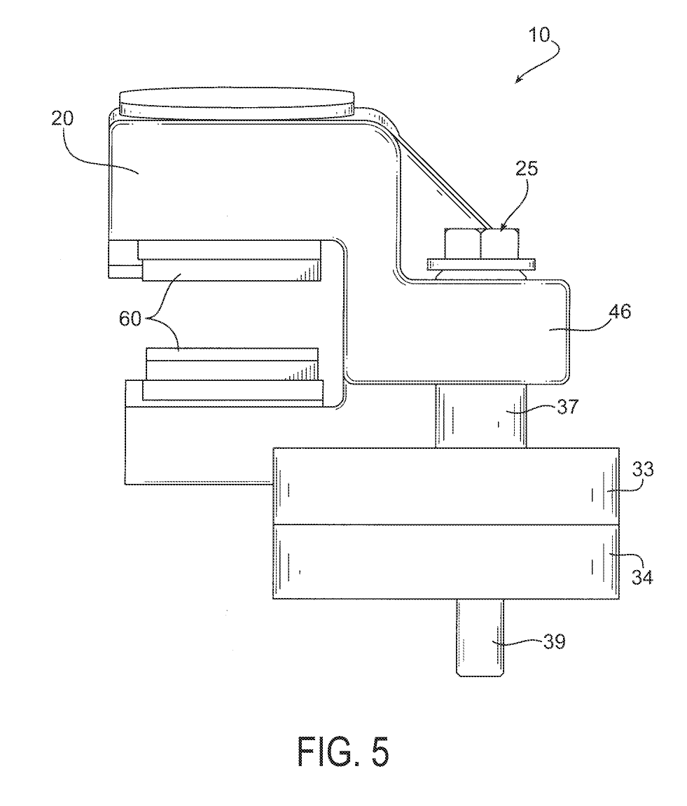

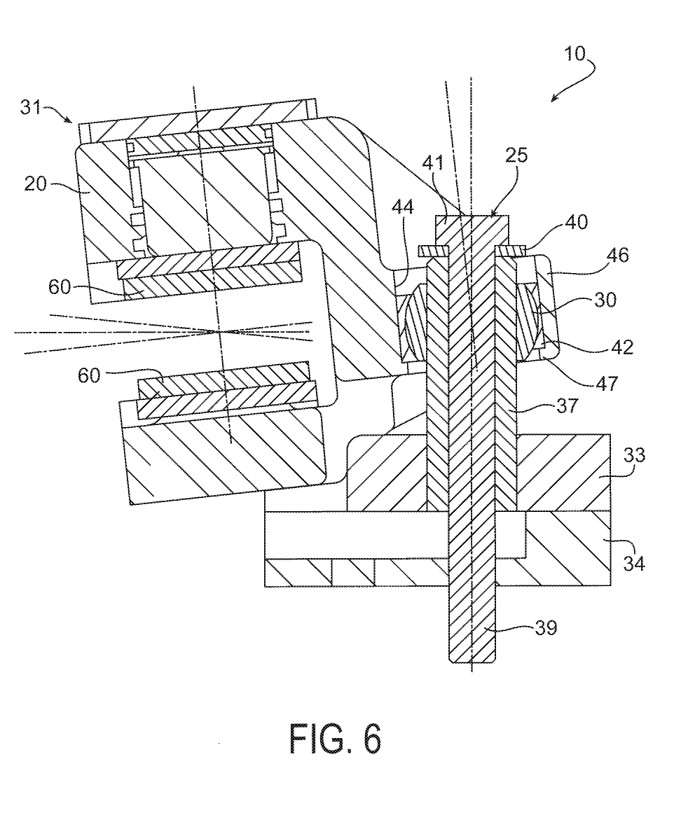

Referring now to FIGS. 3-6, the caliper assembly 20 includes a body 32 which retains the actuator 31; and a base comprising an upper base portion 33 and a lower base portion 34, which are arranged in adjacent, surface to surface relation with each other. The torque pins 25 each comprise an annular sleeve 37 which is closely received in a respective aperture in upper base portion 33 and bottoms against the upper surface of lower base portion 34. The pins further include a threaded retention bolt 39 which is received through a respective torque pin sleeve, and is threadably received in an aperture in the underlying base portion 34 of the brake structure and into appropriate threaded apertures in the underlying base frame. A washer 40 can be located between the enlarged head 41 of bolt 39 and the outer distal end of sleeve 37 to provide even force displacement against the outer end of the sleeve. The torque pins 25 are thereby each rigidly held and fixed on the base structure of the brake.

Bearings 30 each have a central through-hole for receipt of torque pin sleeve 37. Each bearing is held within a race, indicated at 42, which is press-fit and held by friction within through-holes 44 in an outwardly-projecting flange 46 of caliper body 15. The caliper body can also have an annular, turned-in edge portion 47 at the bottom of the through-holes to facilitate retaining the races within the holes. The spherical bearings have a degree of angular movement within their respective races. Bearings 30 also have a dimension which closely receives the torque pin sleeve, but which enables sliding movement of the bearing along the sleeve. As such, caliper body 20, which is fixed to the bearing race, has angular movement (movement about the “Z” axis) with respect to the bearing, and hence with respect to the torque pin, and by extension, the base 33, 34 of the brake and associated base frame. Caliper body likewise has axial movement on the pins (along the “Z” axis) by virtue of the sliding movement of the bearings along the torque pins. Finally, the looseness between the torque pins 25 and the spherical bearings 40 allow a certain degree of freedom of movement of the brake along the “X” and “Y” axis as well.

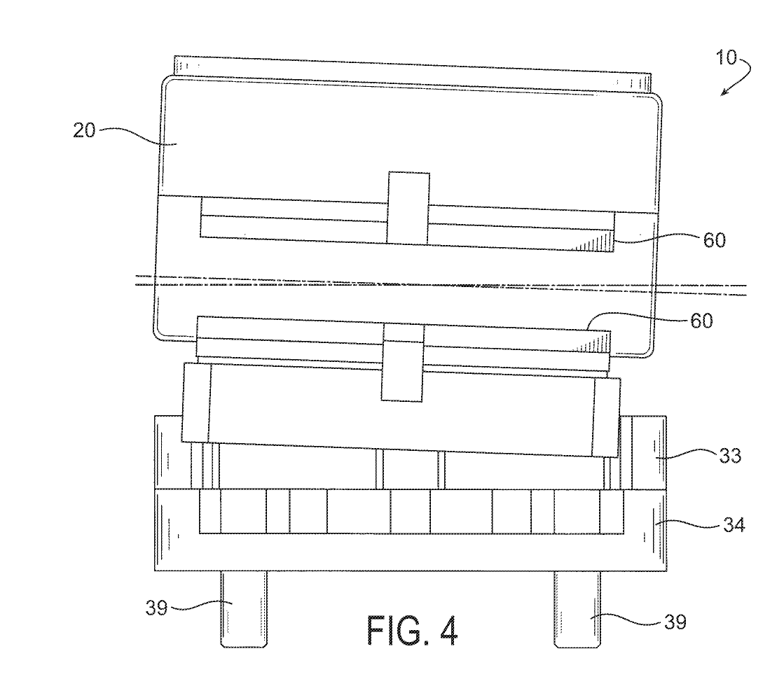

The brake assembly 10 of the present invention provides improvements over the prior art by accommodating misalignment as the floating brake 10 can tilt at different angles to accommodate the brake disc 50 misalignment as best shown in FIGS. 3 and 4. This maintains full contact between the brake linings 60 and the brake disk 50 and results in a full life for the brake linings 60 as a result of the even wear of the brake linings 60.

The yaw brake assembly 10 is also modular in that different actuators, i.e. electric, hydraulic, can be used and be mounted on the same brake structure and bolt hole pattern, such as shown and described in the Modular Actuator Application identified previously. This enables the actuator to be removed from the caliper assembly during repair and maintenance, without having to remove the entire brake.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. Accordingly, the scope and content of the present invention are to be defined only by the terms of the appended claims.

What is claimed is:

1. A yaw brake for a wind turbine having a brake disk, the yaw brake comprising:
a brake caliper;
a brake lining associated with the caliper;
an actuator mounted to the caliper for moving the brake lining against the brake disk;
a plurality of torque pins, each pin mounted through the brake caliper by a spherical bearing such that the caliper has angular and axial movement in relation to the torque pins to reduce misalignment between the brake lining and the brake disk.

2. The yaw brake as in claim 1, wherein the torque pins are fixedly mounted to a base structure, and the brake caliper has angular and axial movement with respect to the base structure.

3. The yaw brake as in claim 2, wherein the torque pins each include a torque sleeve and a threaded bolt extending through the sleeve and fixed to the base structure, wherein the spherical bearing includes a through-hole slidably receiving the sleeve.

4. The yaw brake as in claim 1, wherein the spherical bearing is received within a race, and the race is received and fixed within an opening in a body of the caliper.

5. A yaw brake for a wind turbine having a brake disk, the yaw brake comprising:
a brake caliper having a body and a base structure;
a brake lining associated with the caliper body;
an actuator mounted to the caliper body for moving the lining against the disk; and
a plurality of torque pins fixed to the base structure, each pin mounted through the body of the brake caliper by a spherical bearing supported for angular movement within a race, with the race being fixed within an opening in the body of the caliper, such that the caliper body can tilt and slide in relation to the torque pins and the base structure, to reduce misalignment between the brake lining and the brake disk.

6. The yaw brake as in claim 5, wherein the torque pins each include a torque sleeve and a threaded bolt extending through the sleeve and fixed to the base structure, wherein the spherical bearing includes a through-hole slidably receiving the sleeve.
